(19) United States
(12) Patent Application Publication
(10) Pub. No.: US 2016/0128390 A1
(43) Pub. Date: May 12, 2016

(54) ELECTRONIC CIGARETTE HEAT-GENERATING DEVICE AND ELECTRONIC CIGARETTE

(71) Applicant: KIMREE HI-TECH INC., Road Town, Tortola (VG)

(72) Inventor: Qiuming LIU, Shenzhen, Guangdong (CN)

(21) Appl. No.: 14/901,097

(22) PCT Filed: Jun. 24, 2013
(86) PCT No.: PCT/CN2013/077803

§ 371 Date: Dec. 28, 2015

(51) Int. Cl. A24F 47/00; H05B 3/00; H05B 3/03

(52) U.S. Cl. CPC A24F 47/008; H05B 3/03; H05B 3/0014

(57) ABSTRACT

An electronic cigarette heating device and an electronic cigarette are provided. The electronic cigarette heating device comprises a heating filament, a first electrode, a second electrode, a first riveting terminal, and a second riveting terminal. One end of filament is riveted to first electrode via the first riveting terminal; the other end of heating filament is riveted to second electrode via the second rivet terminal. The outer wall of at least one of the first riveting terminal and second riveting terminal is coated with an insulating layer.

### FIELD OF THE INVENTION

The present invention relates to a field of daily electronic products, and more particularly relates to an electronic cigarette heat-generating device and an electronic cigarette.

### BACKGROUND OF THE INVENTION

Electronic cigarettes are mainly configured for quitting smoking and substituting smoking. Structures of the electronic cigarettes available on the market at the present comprise a heating device and a glass fiber core usually. When the electronic cigarette is working, the heating device is heated, so that tobacco juice absorbed in the glass fiber core is atomized to realize an effect of generating smoke.

As shown in FIG. 1, a heating device in the prior art comprises a heating filament 1, a first electrode 2, a second electrode 3, a first riveting terminal 4 and a second riveting terminal 5. One end portion of the heating filament 1 is riveted to the first electrode 2 via the first riveting terminal 4, and the other end portion of the heating filament 1 is riveted to the second electrode 3 via the second riveting terminal 5. As the first riveting terminal 4 and the second riveting terminal 5 are commonly made of metal material and are electro-conductive, outer surfaces of the first riveting terminal 4 and the second riveting terminal 5 easily contact an outer surface, near the middle portion, of the heating filament 1 to result in a partial short circuit. In this case, when the electronic cigarette is working, the effective resistance of the heating filament 1 is decreased, so that the smoke volume generated by the electronic cigarette is negatively affected to affect a user's taste negatively. Besides, when this kind of electronic cigarette is produced, the consistency of taste of the electronic cigarette can't be ensured, and the quality of the electronic cigarette is low.

### SUMMARY OF THE INVENTION

The objective of the present invention is to provide an electronic cigarette heating device and an electronic cigarette wherein a riveting terminal is electrically insulated with a heating filament, so that a user's taste can't be affected negatively, aiming at the defect that a riveting terminal of the electronic cigarette in the prior art easily contacts a heating filament to result in a partial short circuit to affect the user's taste negatively.

The technical solutions of the present invention for solving the technical problems are as follows.

In one aspect, an electronic cigarette heating device is provided, comprising a heating filament, a first electrode, a second electrode, a first riveting terminal and a second riveting terminal is provided; and one end portion of the heating filament is riveted to the first electrode via the first riveting terminal, and the other end portion of the heating filament is riveted to the second electrode via the second riveting terminal; an insulating layer is covered on an outer surface of an end portion of at least one riveting terminal selected from the first riveting terminal and the second riveting terminal, and the end portion of the at least one riveting terminal is close to the heating filament.

In the electronic cigarette heating device of the present invention, the insulating layer is covered on outer surfaces of one end portion of the first riveting terminal and one end portion of the second riveting terminal; and the insulating layer is insulating paint spray painted on outer surfaces of the first riveting terminal and the second riveting terminal.

In the electronic cigarette heating device of the present invention, the insulating paint is any one kind of paint selected from rubber based paint, silica gel based paint and plastic paint.

In the electronic cigarette heating device of the present invention, the insulating layer is covered on outer surfaces of one end portion of the first riveting terminal and one end portion of the second riveting terminal; and the insulating layer is an insulating sleeve respectively sleeved on outer surfaces of the first riveting terminal and the second riveting terminal.

In the electronic cigarette heating device of the present invention, the insulating sleeve is any one kind of sleeve selected from a rubber sleeve, a silica gel sleeve and a plastic sleeve.

In the electronic cigarette heating device of the present invention, the electronic cigarette heating device further comprises a bonding layer configured for bonding the insulating sleeve to the first riveting terminal and the second riveting terminal respectively.

In the electronic cigarette heating device of the present invention, the insulating sleeves are melted to outer surfaces of the first riveting terminal and the second riveting terminal respectively.

In the electronic cigarette heating device of the present invention, the insulating sleeve is embedded to outer surfaces of the first riveting terminal and the second riveting terminal respectively.

In the electronic cigarette heating device of the present invention, the insulating layer is covered on outer surfaces of one end portion of the first riveting terminal and one end portion of the second riveting terminal; and the insulating layer is an oxidation film respectively formed on surfaces of the first riveting terminal and the second riveting terminal.

In another aspect, an electronic cigarette is provided, and comprises the electronic cigarette heating device according to any one of above technical solutions.

By implementing the electronic cigarette heating device and the electronic cigarette in the present invention, the following advantages can be achieved. The electronic cigarette heating device adopts the structure of the insulating layer that covers an outer surface of at least one riveting terminal selected from the first riveting terminal and the second riveting terminal, so that a surface of the first riveting terminal or the second riveting terminal can be avoided contacting the heating filament effectively and affecting a user's taste negatively. Besides, as the structure of the insulating layers that cover outer surfaces of the first riveting terminal and the second riveting terminal respectively is adopted, the consistency of taste of the produced electronic cigarette is good, and the quality of the electronic cigarette is high.

### BRIEF DESCRIPTION OF THE DRAWINGS

The present invention will be further described with reference to the accompanying drawings and embodiments in the following, in the accompanying drawings:

FIG. 1 is a 3D structural schematic view of an electronic cigarette heating device in the prior art;

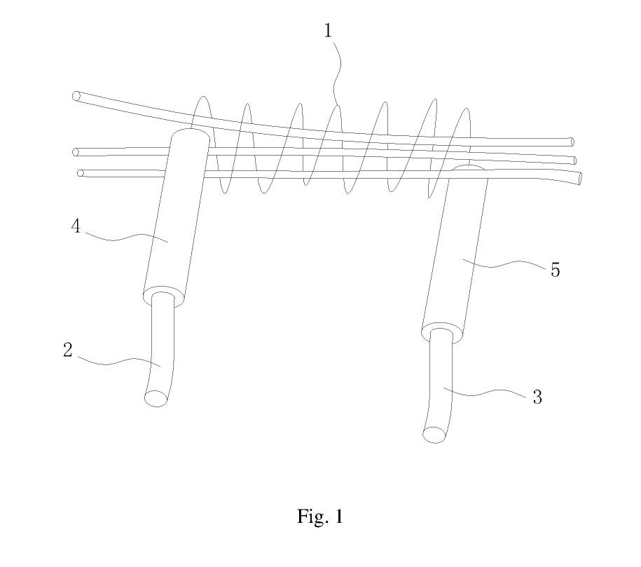

FIG. 2 is a 3D structural schematic view of an electronic cigarette heating device according to a first preferred embodiment of the present invention;

FIG. 3 is a 3D structural schematic view of an electronic cigarette heating device according to a second preferred embodiment of the present invention; and

FIG. 4 is a 3D structural schematic view of an electronic cigarette heating device according to a third preferred embodiment of the present invention.

### DETAILED DESCRIPTION OF THE PREFERRED EMBODIMENT

To make the technical feature, objective and effect of the present invention be understood more clearly, now the specific implementation of the present invention is described in detail with reference to the accompanying drawings and embodiments.

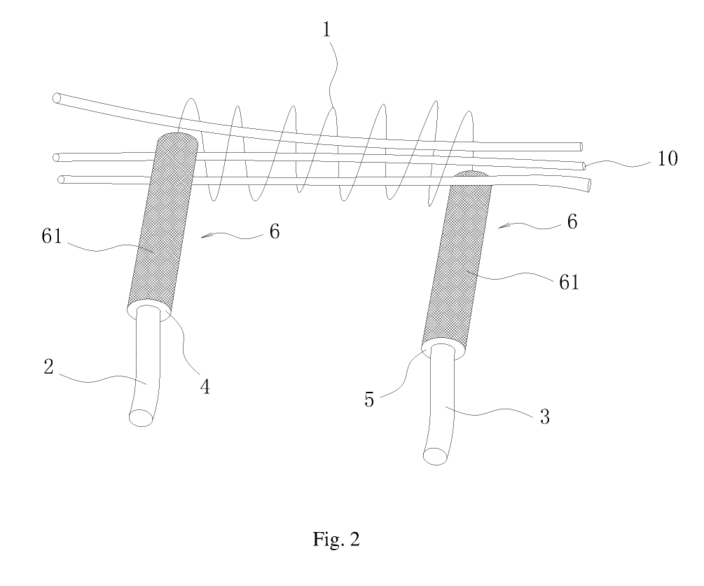

As shown in FIG. 2, an electronic cigarette heating device is provided by a first preferred embodiment of the present invention, and comprises a heating filament 1, a first electrode 2, a second electrode 3, a first riveting terminal 4 and a second riveting terminal 5. The heating filament 1 is twined around a glass fiber core 10, and when the heating filament 1 is working and heated, tobacco juice absorbed in the glass fiber core 10 is atomized to realize an effect of generating smoke. One end portion of the heating filament 1 is riveted to the first electrode 2 via the first riveting terminal 4, and the other end portion of the heating filament 1 is riveted to the second electrode 3 via the second riveting terminal 5. An insulating layer 6 is covered on an outer surface of an end portion of at least one terminal selected from the first riveting terminal 4 and the second riveting terminal 5 and the end portion of the at least one terminal is close to the heating filament 1, so that surfaces of the first riveting terminal 4 and the second riveting terminal 5 can be avoided contacting the heating filament 1 via the insulating layer 6 effectively to ensure electrical resistance stability of the heating filament 1 when the electronic cigarette is working. Thus, the user's taste can't be affected negatively. Besides, as the structure of the insulating layer 6 is adopted, the consistency of taste of the electronic cigarette produced is good, and the quality of the electronic cigarette is high. In the this embodiment, the insulating layer 6 is covered on the entire outer surfaces of the first riveting terminal 4 and the second riveting terminal 5 respectively. It can be understood that the insulating layer 6 can be covered on partial outer surfaces of the first riveting terminal 4 and the second riveting terminal respectively to realize separation between the riveting terminal and the heating filament 1.

Specifically, the insulating layer 6 is covered on outer surfaces of one end portion of the first riveting terminal 4 and one end portion of the second riveting terminal 5. The insulating layer 6 is insulating paint 61 spray painted on outer surfaces of the first riveting terminal 4 and the second riveting terminal 5. The insulating paint 61 has a good insulating property and an adhesive ability, etc.

In the present embodiment, the insulating paint 61 is any one kind of paint selected from rubber based paint, silica gel based paint and plastic paint. The rubber based paint is to spray painted on outer surfaces of the first riveting terminal 4 and the second riveting terminal 5, is matte or semi matte, feels fine and smooth, and has a good insulating property and a wear resistant property, etc. The silica gel based paint is spray painted on outer surfaces of the first riveting terminal 4 and the second riveting terminal 5, and has a good electrical insulation property and a high temperature resistant property, etc. The plastic paint is spray painted on outer surfaces of the first riveting terminal 4 and the second riveting terminal 5, and has high hardness, high gloss and a good insulating property, etc. The outer surfaces of the first riveting terminal 4 and the second riveting terminal 5 adopts the structure generated by spraying with the insulating paint 61. As the spraying method has a high speed, the efficiency of producing the electronic cigarette heating device is high.

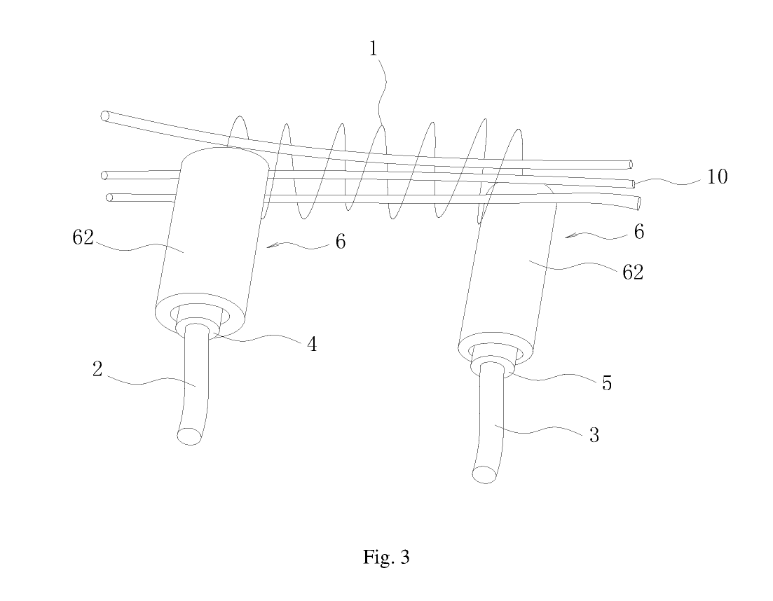

As shown in FIG. 3, an electronic cigarette heating device is provided by a second preferred embodiment of the present invention, and the difference between the second preferred embodiment and the first preferred embodiment lies in the structure of the insulating layer 6. In the present embodiment, the insulating layer 6 is an insulating sleeve 62 respectively sleeved on outer surfaces of the first riveting terminal 4 and the second riveting terminal 5. The insulating sleeve 62 is roughly a hollow cylindrical structure, and matches with the first riveting terminal 4 and the second riveting terminal 5. Surfaces of the first riveting terminal 4 and the second riveting terminal 5 can be avoided contacting the heating filament 1 by adopting the structure of the insulating sleeve 62 effectively, so that the user's taste can't be affected negatively. Advantageously, the thickness of the insulating sleeve 62 is 0.1 mm-0.5 mm.

In the present embodiment, the insulating sleeve 62 is any one kind of sleeve selected from a rubber sleeve, a silica gel sleeve and a plastic sleeve. In order to mount the insulating sleeves 62 on outer surfaces of the first riveting terminal 4 and the second riveting terminal 5 firmly, some methods can be adopted to connect the insulating sleeves 62 to the first riveting terminal 4 and the second riveting terminal 5 respectively. The first method is a bonding method, and the electronic cigarette heating device further comprises bonding layers (not shown in figures) configured for bonding the insulating sleeve 62 to the first riveting terminal 4 and the second riveting terminal 5 respectively. The bonding layer can be glue, double side tape or resin glue, etc. The second method is a melting method, and the insulating sleeve 62 is melted to outer surfaces of the first riveting terminal 4 and the second riveting terminal 5 respectively. The insulating sleeve 62 is heated firstly, and then adhibited on the first riveting terminal 4 and the second riveting terminal 5 respectively. The third method is an embedding method, and the insulating sleeve 62 is embedded to outer surfaces of the first riveting terminal 4 and the second riveting terminal 5 respectively. It can be understood that the connecting method for connecting the insulating sleeve 62, the first riveting terminal 4 and the second riveting terminal 5 is not limited to the aforementioned connecting methods.

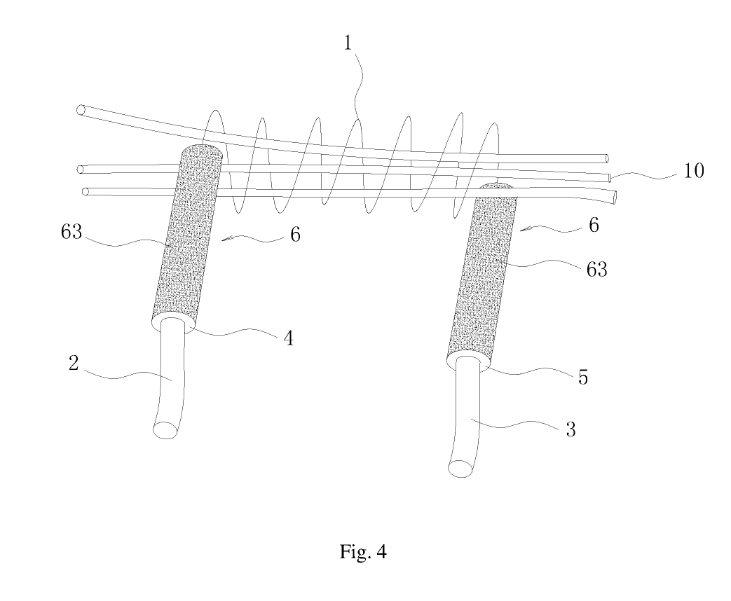

As shown in FIG. 4, an electronic cigarette heating device is provided by a third preferred embodiment of the present invention, and the difference between the third preferred embodiment and the first preferred embodiment lies in the structure of the insulating layer 6. In the present embodiment, the insulating layer 6 is an oxidation film 63 respectively formed on surfaces of the first riveting terminal 4 and the second riveting terminal 5. In the embodiment, before the riveting connection step is started, surfaces of the first riveting terminal 4 and the second riveting terminal 5 can be processed by an oxygenizing and insulating treatment to form the oxidation film 63. Surfaces of the first riveting terminal 4 and the second riveting terminal 5 can be avoided contacting the heating filament 1 via the oxidation film 63 effectively, so that the user's taste can't be affected negatively.

Based on the above structure of the electronic cigarette heating device, the present invention further provides an electronic cigarette which comprises the electronic cigarette heating device according to any one of aforementioned embodiments. The electronic cigarette heating device adopts the structure of the insulating layer 6, so that surfaces of the first riveting terminal 4 and the second riveting terminal 5 can be avoided contacting the heating filament 1 effectively to ensure electrical resistance stability of the heating filament 1 when the electronic cigarette is working. Thus, the user's taste can't be affected negatively. Besides, as the structure of the insulating layer 6 is adopted, the consistency of taste of the produced electronic cigarette is good, and the quality of the electronic cigarette is high.

While the embodiments of the present application are described with reference to the accompanying drawings above, the present invention is not limited to the above-mentioned specific implementations. In fact, the above-mentioned specific implementations are intended to be exemplary not to be limiting. In the inspiration of the present invention, those ordinary skills in the art can also make many modifications without breaking away from the subject of the present application and the protection scope of the claims. All these modifications belong to the protection of the present invention.

1-10. (canceled)

11. An electronic cigarette heating device comprising a heating filament (1), a first electrode (2), a second electrode (3), a first riveting terminal (4) and a second riveting terminal (5), wherein one end portion of the heating filament (1) is riveted to the first electrode (2) via the first riveting terminal (4), and the other end portion of the heating filament (1) is riveted to the second electrode (3) via the second riveting terminal (5); an insulating layer (6) is covered on an outer surface of an end portion of at least one riveting terminal selected from the first riveting terminal (4) and the second riveting terminal (5), and the end portion of the at least one riveting terminal is close to the heating filament (1).

12. The electronic cigarette heating device according to claim 11, wherein the insulating layer (6) is covered on outer surfaces of one end portion of the first riveting terminal (4) and one end portion of the second riveting terminal (5); and the insulating layer (6) is insulating paint (61) spray painted on outer surfaces of the first riveting terminal (4) and the second riveting terminal (5).

13. The electronic cigarette heating device according to claim 12, wherein the insulating paint (61) is any one kind of paint selected from rubber based paint, silica gel based paint and plastic paint.

14. The electronic cigarette heating device according to claim 11, wherein the insulating layer (6) is covered on outer surfaces of one end portion of the first riveting terminal (4) and one end portion of the second riveting terminal (5); and the insulating layer (6) is an insulating sleeve (62) respectively sleeved on outer surfaces of the first riveting terminal (4) and the second riveting terminal (5).

15. The electronic cigarette heating device according to claim 14, wherein the insulating sleeve (62) is any one kind of sleeve selected from a rubber sleeve, a silica gel sleeve and a plastic sleeve.

16. The electronic cigarette heating device according to claim 14, wherein the electronic cigarette heating device further comprises a bonding layer configured for bonding the insulating sleeve (62) to the first riveting terminal (4) and the second riveting terminal (5) respectively.

17. The electronic cigarette heating device according to claim 14, wherein the insulating sleeve (62) is melted to outer surfaces of the first riveting terminal (4) and the second riveting terminal (5) respectively.

18. The electronic cigarette heating device according to claim 14, wherein the insulating sleeve (62) is embedded to outer surfaces of the first riveting terminal (4) and the second riveting terminal (5) respectively.

19. The electronic cigarette heating device according to claim 11, wherein the insulating layer (6) is covered on outer surfaces of one end portion of the first riveting terminal (4) and one end portion of the second riveting terminal (5); and the insulating layer (6) is an oxidation film (63) respectively formed on surfaces of the first riveting terminal (4) and the second riveting terminal (5).

20. An electronic cigarette, wherein the electronic cigarette comprises an electronic cigarette heating device comprising a heating filament (1), a first electrode (2), a second electrode (3), a first riveting terminal (4) and a second riveting terminal (5), wherein one end portion of the heating filament (1) is riveted to the first electrode (2) via the first riveting terminal (4), and the other end portion of the heating filament (1) is riveted to the second electrode (3) via the second riveting terminal (5); an insulating layer (6) is covered on an outer surface of an end portion of at least one riveting terminal selected from the first riveting terminal (4) and the second riveting terminal (5), and the end portion of the at least one riveting terminal is close to the heating filament (1).

21. The electronic cigarette according to claim 20, wherein the insulating layer (6) is covered on outer surfaces of one end portion of the first riveting terminal (4) and one end portion of the second riveting terminal (5); and the insulating layer (6) is insulating paint (61) spray painted on outer surfaces of the first riveting terminal (4) and the second riveting terminal (5).

22. The electronic cigarette according to claim 21, wherein the insulating paint (61) is any one kind of paint selected from rubber based paint, silica gel based paint and plastic paint.

23. The electronic cigarette according to claim 20, wherein the insulating layer (6) is covered on outer surfaces of one end portion of the first riveting terminal (4) and one end portion of the second riveting terminal (5); and the insulating layer (6) is an insulating sleeve (62) respectively sleeved on outer surfaces of the first riveting terminal (4) and the second riveting terminal (5).

24. The electronic cigarette according to claim 23, wherein the insulating sleeve (62) is any one kind of sleeve selected from a rubber sleeve, a silica gel sleeve and a plastic sleeve.

25. The electronic cigarette according to claim 23, wherein the electronic cigarette heating device further comprises a bonding layer configured for bonding the insulating sleeve (62) to the first riveting terminal (4) and the second riveting terminal (5) respectively.

26. The electronic cigarette according to claim 23, wherein the insulating sleeve (62) is melted to outer surfaces of the first riveting terminal (4) and the second riveting terminal (5) respectively.

27. The electronic cigarette according to claim 23, wherein the insulating sleeve (62) is embedded to outer surfaces of the first riveting terminal (4) and the second riveting terminal (5) respectively.

28. The electronic cigarette according to claim 20, wherein the insulating layer (6) is covered on outer surfaces of one end portion of the first riveting terminal (4) and one end portion of the second riveting terminal (5); and the insulating layer (6) is an oxidation film (63) respectively formed on surfaces of the first riveting terminal (4) and the second riveting terminal (5).
